(19) United States
(12) Patent Application Publication
(10) Pub. No.: US 2008/0172830 A1
(43) Pub. Date: Jul. 24, 2008

(54) Knife-used handle set

(76) Inventor: Min Zheng Zeng, Nantou City (TW)

Correspondence Address: Dr. BANGER SHIA, 102 Lindencrest Ct., Sugar Land, TX, 77479-5201, US

(21) Appl. No.: 11/625,989

(22) Filed: Jan. 23, 2007

(51) Int. Cl. B26B 11/00

(52) U.S. Cl. 16/111.1

(57) ABSTRACT

A knife-used handle set includes a handle, a holder and a lock. The handle includes a front portion for receiving a working blade, a rear portion and at least one blade-holding cavity defined in a side of the rear portion. The holder includes at least one cover for insertion in the blade-holding cavity, a blade-holding frame formed on an internal side of the cover and a groove defined in the blade-holding frame for receiving spare blades. The lock can lock the cover in the blade-storing cavity.

### BACKGROUND OF INVENTION

1. Field of Invention

The present invention relates to a knife and, more particularly, to a knife-used handle set for easy storage and retrieving of spare blades.

2. Related Prior Art

There are so-called heavy-duty designer s knifes for cutting thin wood or acrylic panels. Such a knife includes a handle and a blade connected to the handle. Such blades are disposable. A blunt used blade has to be replaced with a sharp new blade. Such a blade includes two tips.

The handle is hollow for storing spare blades. A sliding door is used to keep the spare blades in the hollow handle. The spare blades however rattle and make loud noises in the hollow handle. Moreover, the operation of the sliding door is inconvenient.

There have been some handles with positioning devices for holding spare blades in position. Their structures are however complicated and their costs are high. Therefore, they are weak in competition and low in economic benefit.

The present invention is therefore intended to obviate or at least alleviate the problems encountered in prior art.

### SUMMARY OF INVENTION

It is an objective of the present invention to provide a structurally simple handle for a knife.

According to the present invention, a knife-used handle set includes a handle, a holder and a lock. The handle includes a front portion for receiving a working blade, a rear portion and at least one blade-holding cavity defined in a side of the rear portion. The holder includes at least one cover for insertion in the blade-holding cavity, a blade-holding frame formed on an internal side of the cover and a groove defined in the blade-holding frame for receiving spare blades. The lock can lock the cover in the blade-storing cavity.

Other objectives, advantages and features of the present invention will become apparent from the following description referring to the attached drawings.

### BRIEF DESCRIPTION OF DRAWINGS

The present invention will be described through detailed illustration of the preferred embodiment referring to the drawings.

FIG. 1 is an exploded view of a knife including blades and a handle set including a handle, a holder and a lock according to the preferred embodiment of the present invention.

FIG. 2 is a perspective view of the knife shown in FIG. 1.

FIG. 3 is a cut-away view of the knife shown in FIG. 2.

FIG. 4 is a cut-away view of the knife, showing the lock pivoted to a releasing position from a locking position shown in FIG. 3.

FIG. 5 is a cut-away view of the knife, showing the holder detached from the handle instead of joined as shown in FIG. 4.

FIG. 6 is a perspective view of the holder shown in FIG. 1.

### DETAILED DESCRIPTION OF PREFERRED EMBODIMENT

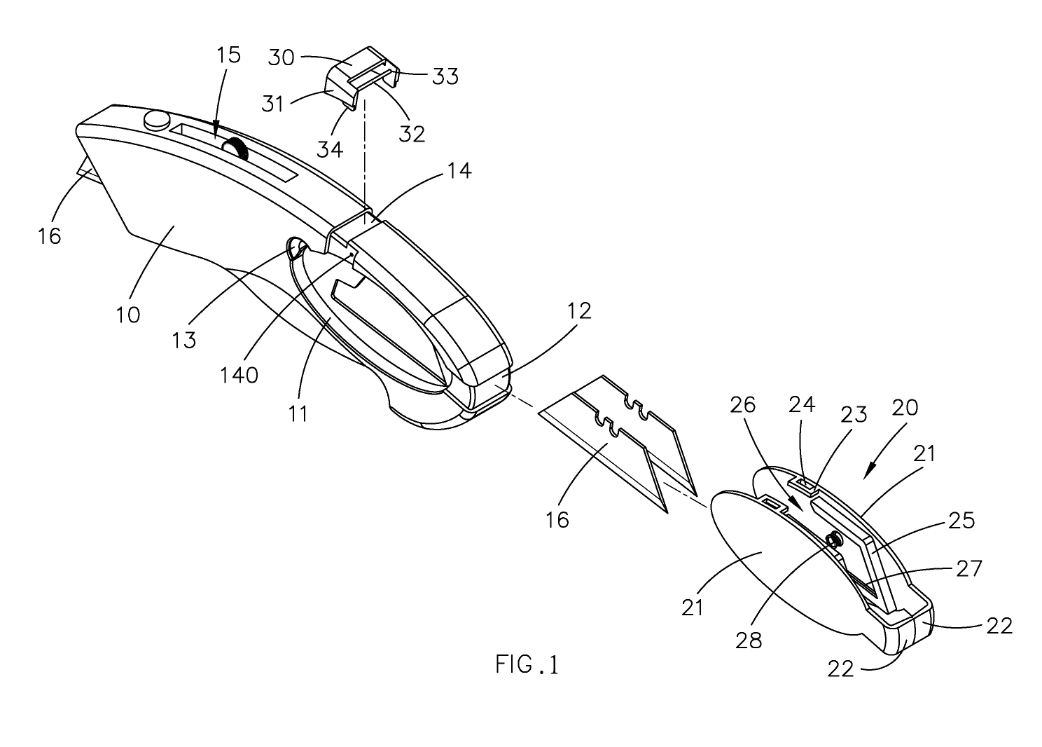

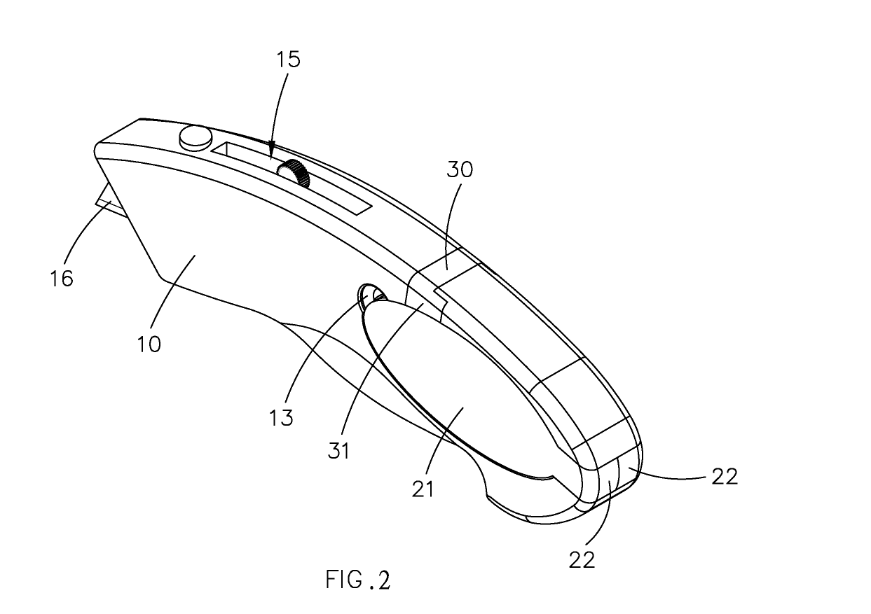

Referring to FIGS. 1 through 5, a knife includes blades 16 and a handle set according to the preferred embodiment of the present invention. The blades 16 include a working blade 16 and spare blades 16. The handle set includes a handle 10, a holder 20 and a lock 30. The working blade 16 is attached to a front portion of the handle 10 while the spare blades 16 can be kept on a rear portion of the handle 10 by the holder 20. The holder 20 can be locked on the rear portion of the handle 10 by the lock 30.

Referring to FIGS. 1 through 3, the working blade 16 can be fed by a feeder 15 arranged in the front portion of the handle 10. The feeder 15 will not be described in detail for being conventional.

A blade-storing cavity 11 and a finger-receiving cavity 13 are defined in each side of the rear portion of the handle 10 so that they are in communication with each other. The blade-storing cavities 11 are in communication with each other through a channel 12 defined in the rear portion of the handle 10. Moreover, the blade-storing cavities 11 are in communication with each other through a lock-receiving cavity 14 defined in the top of the rear portion of the handle 10. A tunnel 140 is defined in the rear portion of the handle 10 within the lock-receiving cavity 14.

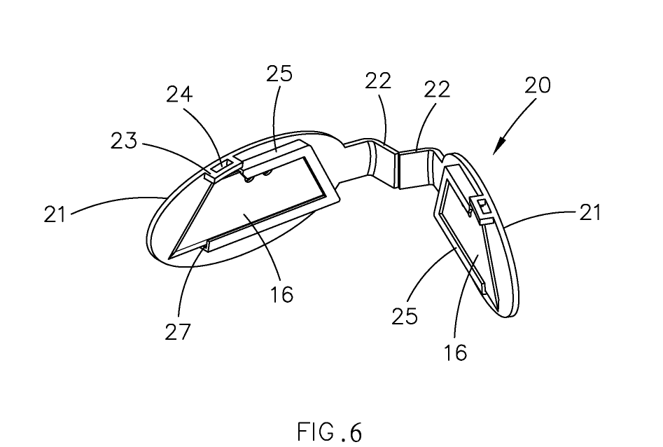

Referring to FIGS. 1 and 6, the holder 20 includes two covers 21 and a connector 22 for interconnecting the covers 21. The covers 21 are separated from each other by a gap 26. An aperture 24 is defined in a lug 23 formed on each of the covers 21. A blade-holding frame 25 is formed on an internal side of each of the covers 21. A groove 27 is defined in each of the blade-holding frames 25. An elastic element 28 is attached to the internal side of each of the covers 21.

The lock 30 includes two fins 31 and a connector for interconnecting the fins 31. A latch 34 is extended from each of the fins 31. A pin 32 is arranged between the fins 31. The pin 32 is inserted through the tunnel 140 so that the lock 30 is pivotally connected to the handle 10.

In use, the spare blades 16 are inserted into the grooves 27 defined in the blade-holding frames 25. The spare blades 16 are abutted against the elastic elements 28. Thus, the spare blades 16 cannot rattle on the blade-holding frames 25.

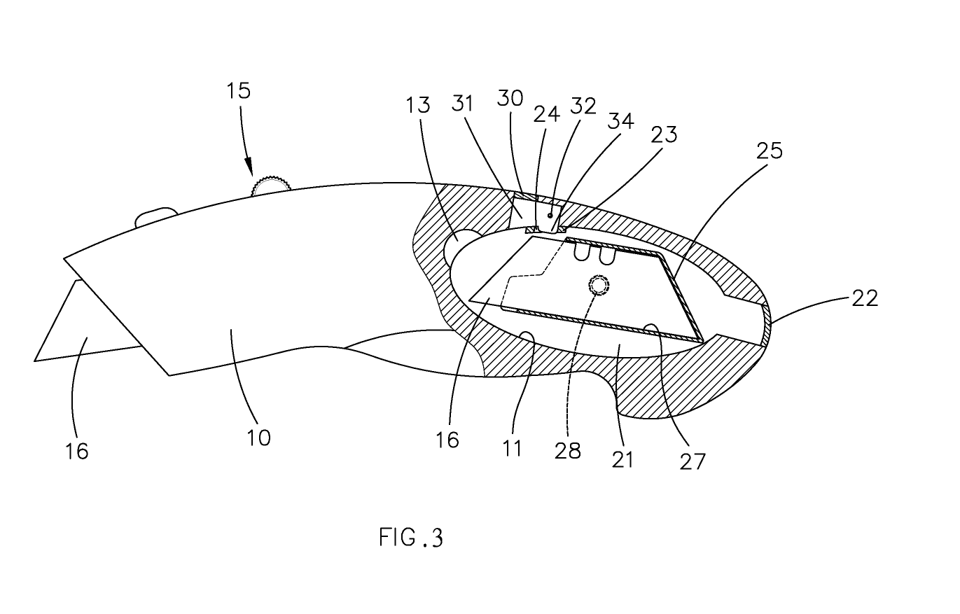

Referring to FIG. 3, the covers 21 are located in the blade-storing cavities 11. The connector 22 is located in the channel 12. The lock 30 is located in the lock-receiving cavity 14. The handle 10, the holder 20 and the lock 30 are flush with one another. The latches 34 are inserted in the apertures 24 so that the holder 20 is locked on the rear portion of the handle 10. Thus, the spare blades 16 are kept on the holder 20.

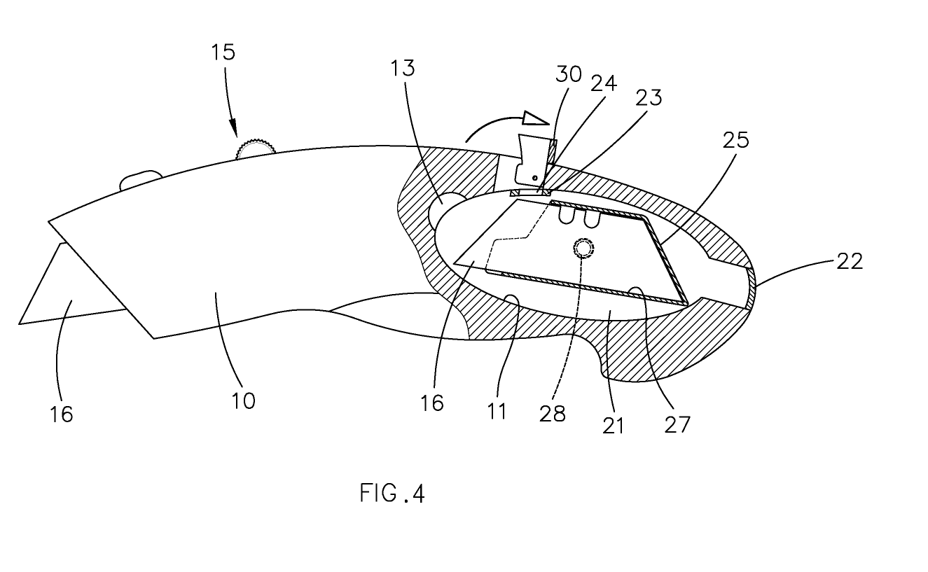

Referring to FIG. 4, the lock 30 is pivoted to a releasing position from the locking position shown in FIG. 3. The latches 34 are removed from the apertures 24.

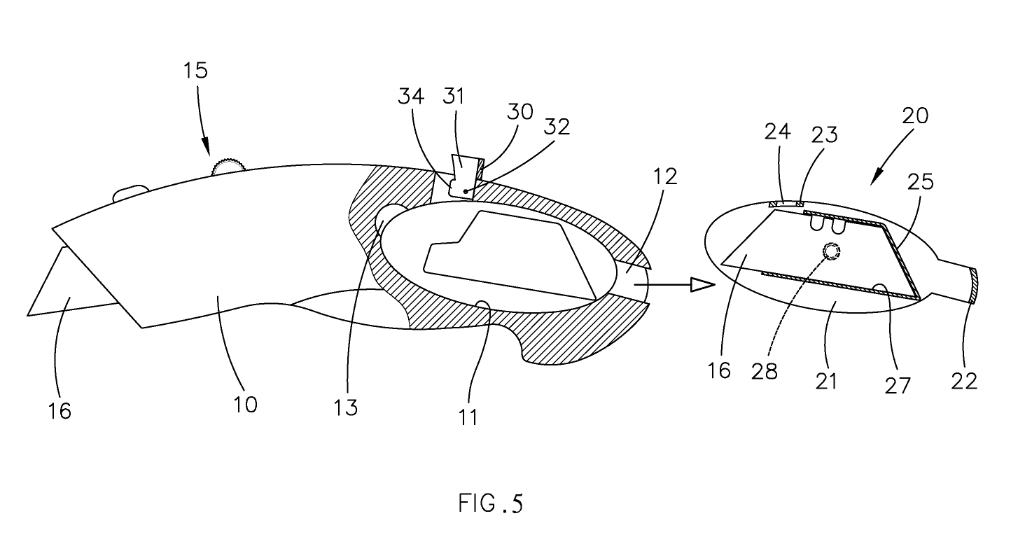

Referring to FIG. 5, the covers 21 are moved from the blade-storing cavities 11. A user s fingers can be inserted in the finger-receiving cavities 13 to pivot the covers 21.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

1. A knife-used handle set comprising:
a handle comprising a front portion for receiving a working blade, a rear portion and at least one blade-holding cavity defined in a side of the rear portion;
a holder comprising at least one cover for insertion in the blade-holding cavity, a blade-holding frame formed on an internal side of the cover and a groove defined in the blade-holding frame for receiving spare blades; and
a lock for locking the cover in the blade-storing cavity.

2. The knife-used handle set according to claim 1 wherein the handle defines a finger-receiving cavity in communication with the blade-storing cavity so that a finger can be inserted in the finger-receiving cavity to maneuver the cover disposed in the blade-storing cavity.

3. The knife-used handle set according to claim 1 wherein the holder comprises an elastic element attached to the cover for abutting the spare blades.

4. The knife-used handle set according to claim 1 wherein the holder comprises a lug formed on the cover, and the lock comprises a latch for insertion in the lug.

5. The knife-used handle set according to claim 4 wherein the lock is located on a top of the handle so that latch is kept in the lug by the weight thereof.

6. The knife-used handle set according to claim 1 wherein the lock is pivotally connected to the rear portion of the handle.

7. The knife-used handle set according to claim 1 wherein the handle defines two blade-storing cavities on two opposite sides, the holder comprises two covers, and the lock is used to lock the covers in the blade-storing cavities.

8. The knife-used handle set according to claim 7 wherein the holder comprises a lug formed on each of the covers, and the lock comprises two latches for insertion in the lugs.

9. The knife-used handle set according to claim 8 wherein the handle defines a lock-receiving cavity for receiving the lock.

10. The knife-used handle set according to claim 7 wherein the holder comprises a connector for interconnecting the covers.

11. The knife-used handle set according to claim 10 wherein the handle defines a channel for receiving the connector.
